(19) United States
(12) Patent Application Publication
(10) Pub. No.: US 2006/0129829 A1
(43) Pub. Date: Jun. 15, 2006

(54) Methods, systems, and computer program products for accessing data with a plurality of devices based on a security policy

(76) Inventors: Jeffrey A. Aaron, Atlanta, GA (US); Jun-Gang Alin, Duluth, GA (US)

Correspondence Address: MYERS BIGEL SIBLEY & SAJOVEC, PO BOX 37428, RALEIGH, NC, 27627, US

(21) Appl. No.: 11/010,549

(22) Filed: Dec. 13, 2004

(51) Int. Cl. H04L 9/00

(52) U.S. Cl. 713/182

(57) ABSTRACT

A method of accessing data with a first terminal and a second terminal includes providing access to first data using a first terminal and detecting an available second terminal within a proximity of the first terminal. The second terminal is identified as a preferred terminal based on a security policy. At least a portion of the first data is automatically transferred to the second terminal over a wireless interface responsive to detection of the second terminal and identification of the second terminal as the preferred terminal. Access to the first data is then provided using the second terminal. Related systems and computer program products are also discussed.

### FIELD OF THE INVENTION

The present invention relates to communications networks, and, more particularly, to accessing data using multiple devices in a communications network.

### BACKGROUND OF THE INVENTION

Communications networks are widely used for nationwide and worldwide communication of voice, multimedia and/or data. As used herein, communications networks may include public communications networks, such as the Public Switched Telephone Network (PSTN), terrestrial and/or satellite cellular networks, local area and/or wide area networks, and/or the Internet. The Internet is a decentralized network of computers that can communicate with one another via Internet Protocol (IP). The Internet includes a World Wide Web (WWW) of client-server-based facilities that include a large number of servers (computers connected to the Internet) on which Web pages or files reside, as well as clients (Web browsers) that can interface users with the client-server facilities. The topology of the World Wide Web can be described as a network of networks, with providers of network services called Network Service Providers, or NSPs. Servers that provide application-layer services may be referred to as Application Service Providers (ASPs). Sometimes a single service provider provides both functions.

Users of communications networks have been increasingly mobile. Mobile terminals, such as cellular telephones and PDA's, can provide mobile connectivity to communications networks, and increasingly include functionality available on stationary devices such as desktop PC's and televisions. In particular, mobile terminals can include sufficient memory and processing capabilities to allow users to access applications and data that previously required a PC.

Stationary devices, however, may offer users more convenient and/or less tiring interaction with the applications and data. For example, the larger screen area and input devices provided by PC's and televisions may be easier and/or less taxing for the user to operate. As such, users may wish to utilize both mobile and stationary devices to access data for their convenience.

### SUMMARY OF THE INVENTION

According to some embodiments of the present invention, a method of accessing data with a first terminal and a second terminal may include providing access to first data using a first terminal and detecting an available second terminal within a proximity of the first terminal. The second terminal may be identified as a preferred terminal based on a security policy, and at least a portion of the first data may be automatically transferred to the second terminal over a wireless interface responsive to detection of the second terminal and identification of the second terminal as the preferred terminal. Access to the first data may then be provided using the second terminal. Note that, as used herein, “accessing data” and “providing access to data” may include selecting and employing an appropriate and/or preferred method, such as an appropriate and/or preferred software application and associated parameters, options, and settings.

In some embodiments, the first terminal may be a mobile terminal, and the second terminal may be a stationary terminal.

In other embodiments, identifying the second terminal as a preferred terminal based on a security policy may include identifying the second terminal as a preferred terminal based on security ratings that are associated with a user of the first terminal, the first data, the first terminal, and/or the second terminal. In further embodiments, current security conditions associated with a user of the mobile terminal, the first data, the first terminal, and/or the second terminal may be detected, and the security ratings may be modified based on the detected security conditions.

In still further embodiments, detecting current security conditions may include detecting a presence of other parties within a proximity of the second terminal and/or other connections to the second terminal. Detecting the presence of other parties may include detecting a third terminal within a proximity of the first terminal.

In some embodiments, identifying a preferred terminal may further include identifying the second terminal as a preferred terminal based on an identity of a user, preferences specified by the user, and/or historical determinations of a preferred terminal for the user and/or similar users.

In other embodiments, identifying the second terminal as a preferred terminal may include accessing a security policy stored on a central server, and automatically transferring may include automatically transferring at least a portion of the first data to the second terminal via the central server.

In further embodiments, second data addressed to the first terminal may be redirected to the second terminal when the second terminal is within the proximity of the first terminal.

In other embodiments, a loss of proximity may be detected between the first terminal and the second terminal. The first terminal may be identified as a preferred terminal based on the security policy, and at least a portion of the first data may be automatically transferred to the first terminal responsive to detecting the loss of proximity and identification of the first terminal as the preferred terminal.

In some embodiments, automatically transferring may include prompting a user of the mobile terminal to authorize transferring the first data to the second terminal. The first data may be transferred to the second terminal responsive to the user authorization.

According to other embodiments of the present invention, a system for accessing data with a plurality of devices may include a first terminal configured to provide access to first data and a second terminal configured to provide access to the first data. The first terminal may be further configured to detect the second terminal within a proximity of the first terminal, identify the second terminal as a preferred terminal based on a security policy, and automatically transfer at least a portion of the first data to the second terminal over a wireless interface responsive to detecting the second terminal and determining the preferred terminal.

According to further embodiments of the present invention, a computer program product for accessing data using a first terminal and a second terminal may include a computer readable storage medium having computer readable program code embodied therein. The computer readable program code may include computer readable program code that is configured to provide access to first data using a first terminal and computer readable program code that is configured to detect an available second terminal within a proximity of the first terminal. The computer readable program code may also include computer readable program code that is configured to identify the second terminal as a preferred terminal based on a security policy and computer readable program code that is configured to automatically transfer at least a portion of the first data to the second terminal over a wireless interface responsive to detecting the second terminal and identifying the second terminal as the preferred terminal. In addition, the computer readable program code may further include computer readable program code that is configured to provide access to the first data using the second terminal.

Embodiments of the invention have been described above primarily with respect to methods of accessing data with a plurality of devices. However, other embodiments of the invention can provide systems and computer program products that may be used to access data with a plurality of devices. Other methods, systems, and/or computer program products according to other embodiments of the invention will be or become apparent to one with skill in the art upon review of the following drawings and detailed description. It is intended that all such additional methods, systems, and/or computer program products be included within this description, be within the scope of the present invention, and be protected by the accompanying claims.

### BRIEF DESCRIPTION OF THE DRAWINGS

FIG. 1 is a schematic block diagram illustrating a communication system and methods according to some embodiments of the present invention;

FIG. 2 a schematic block diagram illustrating a communication system and methods including a mobile terminal according to some embodiments of the present invention;

FIG. 3 is a flowchart illustrating operations for accessing data with a plurality of devices according to some embodiments of the present invention; and

FIG. 4 is a flowchart illustrating operations for accessing data with a mobile terminal and a stationary terminal according to some embodiments of the present invention.

### DETAILED DESCRIPTION OF EMBODIMENTS OF THE INVENTION

The present invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout. As used herein the term “comprising” or “comprises” is open-ended, and includes one or more stated elements, steps and/or functions without precluding one or more unstated elements, steps and/or functions. As used herein the term “and/or” includes any and all combinations of one or more of the associated listed items.

The present invention may be embodied as methods, systems, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments according to the present invention are described with reference to block diagrams and/or operational illustrations of methods, systems, and computer program products. It is to be understood that each block of the block diagrams and/or operational illustrations, and combinations of blocks in the block diagrams and/or operational illustrations, can be implemented by radio frequency, analog and/or digital hardware, and/or computer program instructions. These computer program instructions may be provided to a processor circuit of a general purpose computer, special purpose computer, ASIC, and/or other programmable data processing apparatus, such that the instructions, which execute via the processor of the computer and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

The computer program instructions may be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Finally, it will be understood that, although the terms first, second, etc. may be used herein to describe various elements, these elements should not be limited by these terms. These terms are only used to distinguish one element from another. For example, a first rule could be termed a second rule, and, similarly, a second rule could be termed a first rule without departing from the teachings of the disclosure.

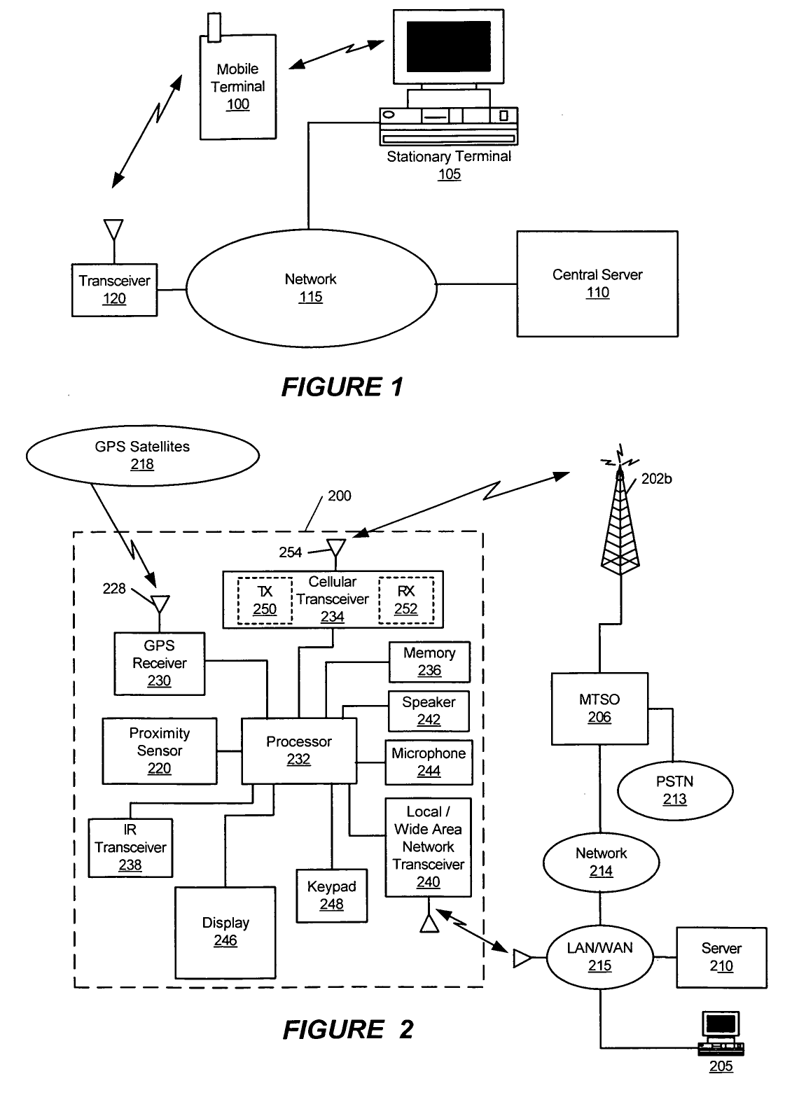

FIG. 1 is a schematic block diagram illustrating a communication system and methods according to some embodiments of the present invention. The communication system includes a mobile terminal 100, a stationary terminal 105, a central server 110, a network 115, and a network transceiver 120. The mobile terminal 100 and the stationary terminal 105 may communicate with the central server 110 via the network 115. More particularly, the mobile terminal 100 and the stationary terminal 105 may be configured to provide access to data which may be stored on the central server 110 in, for example, a database. As used herein, “access” refers to the ability of a user to view and/or edit data, such as with the display of the terminals 100 and/or 105.

According to some embodiments of the invention, data may be automatically transferred between the mobile terminal 100, the stationary terminal 105, and/or the central server 110 based on a security policy. In particular, the security policy may be used to identify the mobile terminal 100 or the stationary terminal 105 as a preferred terminal. As such, access to the data may be provided using the mobile terminal 100 and/or the stationary terminal 105, depending on which one is identified as the preferred terminal. Data may be transferred between the mobile terminal 100, the stationary terminal 105, and/or the central server 110 over the network 115 via the network transceiver 120. Alternatively, data may be transferred directly between the mobile terminal 100 and the stationary terminal 105 using a wired and/or wireless connection.

The network 115 may represent a global network, such as the Internet, or other publicly accessible network. The network 115 may also, however, represent a wide area network, a local area network, an Intranet, or other private network, which may not be accessible by the general public. Furthermore, the network 115 may represent a combination of one or more wired and/or wireless public and/or private networks and/or virtual private networks (VPN).

As used herein, the mobile terminal 100 may include, but is not limited to, a terminal with data processing capabilities that is configured to send and/or receive communication signals via a wireless interface. The mobile terminal 100 may be configured to communicate via a wireless protocol such as, for example, a cellular protocol (e.g., General Packet Radio System (GPRS), Enhanced Data Rates for Global Evolution (EDGE), Global System for Mobile Communications (GSM), code division multiple access (CDMA), wideband-CDMA, CDMA2000, and/or Universal Mobile Telecommunications System (UMTS)), a wireless local area network protocol (e.g., IEEE 802.11), a Bluetooth protocol, an Ultra Wide Band (UWB) protocol, another RF communication protocol, the Internet Protocol (IP) suite, and/or an optical communication protocol. For example, the mobile terminal 100 may be a cellular mobile terminal; a personal communication terminal that may combine a cellular mobile terminal with data processing, facsimile and data communications capabilities; a personal digital assistant (PDA) that can include a wireless receiver, Internet/intranet access, local area network interface, wide area network interface, and/or Web browser; and a mobile computer or other device that includes a wireless receiver.

The stationary terminal 105 may be any device having data processing capabilities. For example, the stationary terminal 105 may be a desktop computer. Alternatively, the stationary terminal 105 may be a mobile terminal that is presently stationary, such as a portable/laptop computer. The stationary terminal 105 may be configured to communicate with the mobile terminal 100 and/or the central server 110 via a wireless and/or a wired interface.

The central server 110 may be embodied as one or more enterprise, application, personal, pervasive and/or embedded computing devices that may be interconnected by a wired and/or wireless local and/or wide area network, including the Internet. The central server 110 may include and/or communicate with one or more databases containing the security policy and/or user information. The security policy may include device security ratings for the mobile and stationary terminals and session security ratings. The user information may include information such as user preferences, historical data, event logs, rule parameters, and/or alerts/alarms, and may be stored in a preference/history database. The central server 110 may process the security ratings and preferences from the databases using pre-configured rules to determine a preferred terminal. In some embodiments, the central server 110 may be situated in a secure location, such as the central office of a communications services provider.

The central server 110 may also provide an interface between the mobile terminal 100 and/or the stationary terminal 105 and external network communications, such as e-mail. For example, external services may contact the central server 110 to determine the “current” device for a particular user in order to forward communications to the device that is currently being used. The external services may also receive communications from the terminals 100 and 105 and/or the central server 110 indicating that a device is no longer current, and may contact the central server 110 for additional information.

Although FIG. 1 illustrates an exemplary communication system and methods, it will be understood that the present invention is not limited to such configurations, but is intended to encompass any configuration capable of carrying out the operations described herein. For example, while FIG. 1 illustrates that the mobile terminal 100 and the stationary terminal 105 provide access to data stored on the central server 110, the data may be stored on the mobile terminal 100 and/or the stationary terminal 105. In other words, the central server 110 may not be present. As such, the mobile terminal 100 may store the data internally and transfer the data directly to the stationary terminal 105 to provide access to the data. Also, the mobile terminal 100 may be configured to directly communicate with the stationary terminal 105 via a wireless and/or wired connection, rather than over the network 115. Furthermore, the mobile terminal 100 may be configured to transfer data to another mobile terminal rather than to the stationary terminal 105. For example, a user of one mobile terminal, such as a PDA, may transfer data to another mobile terminal, such as a laptop computer.

Some embodiments of the present invention may arise from recognition that it may be desirable for users to more easily utilize both mobile and stationary devices for their convenience. However, transferring data between mobile and stationary devices typically requires action by the user (and often, multiple user actions and/or decisions), which may greatly reduce user convenience. As such, the transfer of data between the devices may be accomplished automatically, dependent on the location of users and their proximity to devices, as well as user preferences. For such an automatic transfer to be safely accomplished, user security and privacy may also be considered.

Embodiments of the present invention may provide, methods, systems and computer program products that allow a user to access data with a mobile terminal and/or a stationary terminal within a proximity of the mobile terminal, and may provide automatic data transfer between the devices. The transfer of data between devices may be controlled so as to maintain the user's desired security and privacy with respect to the interaction. The transfer of data may also include consideration of the user's preferences, changes in security conditions, and/or the presence of other parties within a proximity (or likely to be in a proximity) of the devices.

FIG. 2 is a schematic block diagram of a wireless communication system and methods that includes a mobile terminal 200 that communicates wireless signals with a cellular base station 202b and/or a wireless local/wide area network 215, and may receive Global Positioning System location information from GPS satellites 218. The cellular base station 202b is connected to a Mobile Telephone Switching Office (MTSO) 206 wireless network, which, in turn, is connected to a Public Switched Telephone Network (PSTN) 213, and a network 214 (e.g., Internet). The wireless local/wide area network 215 is connected to the network 214, and may be connected to other devices, such as stationary terminal 205. The mobile terminal 200 may communicate with the wireless local/wide area network 215 using a communication protocol that may include, but is not limited to, 802.11a, 802.11b, 802.11e, 802.11g, 802.11i, and/or other wireless local area network protocols and/or may receive wide area signals as, for example, digital TV signals and/or digital radio signals. The mobile terminal 200 may communicate with other devices, such as the stationary terminal 205, directly using infrared, Bluetooth, Ultra Wide Band, Wi-Fi, and/or other wireless protocol, or indirectly via the wireless local/wide area network 215. The wireless local/wide area network 215 may be an Intranet and/or other private network. The wireless local/wide area network 215 may also include a server 210. The server 210, the stationary terminal 205, and the local/wide area network 215 may respectively correspond to the central server 110, the stationary terminal 105, and the network 115 of FIG. 1.

In some embodiments of the present invention, the mobile terminal 200 includes a proximity sensor 220, a GPS receiver 230, an infrared (IR) transceiver 238, a processor 232, a cellular transceiver 234, memory 236, and a local/wide area network transceiver 240. The mobile terminal 200 may also include a speaker 242, a microphone 244, a display 246 and a keypad 248. The proximity sensor 220 may be configured to detect the presence of other parties and/or devices using the local/wide area network transceiver 240, the IR transceiver 238, the GPS receiver 230, and or other detection methods.

Proximity may be detected by the proximity sensor 220 based on the presence of an identification signal from a terminal, in which case the signal may be low power and/or line of sight. An approximate distance between the terminals may also be determined based on the power level of the received identification signal. In other embodiments, proximity may be calculated by timing such that, for example, a time period between transmission of a signal (such as a medium power pulsed identification signal) and receipt of a response from another terminal, is measured, with the speed of the signal multiplied by the time to obtain the distance from which proximity may be determined. In still other embodiments, a GPS signals and/or other location signals may be used to determine the location of terminals and/or their relative proximities.

For example, the local/wide area network transceiver 240 can receive, and may also transmit, signals to the wireless local/wide area network 215, and may request therefrom information on the position of the mobile terminal 200. The local/wide area network transceiver 240 may also support formation of an ad hoc wireless local area network between the mobile terminal 200 and additional devices. For example, a mobile terminal 200 can determine the presence of other devices within a proximity of the mobile terminal 200 based on identification signals transmitted by the devices and received by the local/wide area network transceiver 240. The mobile terminal 200 may then use the local/wide area network transceiver 240 to establish a wireless data connection with one or more of the detected devices. The local/wide area network transceiver 240, for example, may be provided according to a Wi-Fi (IEEE 802.11) standard and/or a Bluetooth standard.

Alternatively, the IR transceiver 238 may be used to determine the presence of other devices within a proximity of the mobile terminal 200. The IR transceiver 238 can detect infrared signals transmitted by the other devices. The direction(s) of the other devices relative to the mobile terminal 200 may also be determined based on the direction of the detected infrared signals. The mobile terminal 200 may then use the IR transceiver 238 to establish a wireless data connection with one or more of the detected devices using infrared coupling(s).

As a further alternative, the GPS receiver 230 may be used to determine the location of the mobile terminal 200 relative to other devices that communicate with the server 210 by communicating its geographic position to the server 210, such as, for example, via a GPRS packet network communication connection through the MTSO 206 and/or via the wireless local/wide area network 215. When the server 210 determines that the mobile terminal 200 is within a proximity of the other devices, the mobile terminal 200 may then establish a wireless data connection with one or more of the detected devices as described above.

In further embodiments of the invention, the proximity sensor 220 may include multiple directional sensors which may be used to identify the approximate direction of the detected terminal relative to the mobile terminal 200 based on transmission and/or reception of identification signals. For example, four sensors in tetrahedral arrangement may be used to provide approximate three-dimensional directional information. Alternatively, an electronic compass and a gravity sensor may be used provide an approximate coordinate system. Other techniques of detecting proximity also may be used in various embodiments of the present invention.

The cellular transceiver 234 includes both a transmitter (TX) 250 and a receiver (RX) 252 to allow two-way communications. The mobile terminal 200 may thereby communicate with one or more of the base stations 202b using radio frequency signals, which may be communicated through an antenna 254. For example, the mobile terminal 200 may be configured to communicate via the cellular transceiver 234 using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS). Communication protocols as used herein may specify the information communicated, the timing, the frequency, the modulation, and/or the operations for setting-up and/or maintaining a communication connection.

The memory 236 may store software that is executed by the processor 232, and may include one or more erasable programmable read-only memories (EPROM or Flash EPROM), battery backed random access memory (RAM), magnetic, optical, or other digital storage device, and may be separate from, or at least partially within, the processor 232. The memory 236 may include several categories of software and data, such as an operating system, applications programs, input/output (I/O) device drivers, and data. In some embodiments, the memory 236 may include one or more databases containing a security policy for the mobile terminal, user information/preferences, and/or other information which may be used to identify the mobile terminal and/or other device as a preferred terminal. In other embodiments, these databases may be included in the server 210.

The processor 232 may be, for example, a commercially available or custom microprocessor that is configured to coordinate and manage operations of the mobile terminal 200. As such, the processor 232 may be configured to manage detection of other available devices within a proximity of the mobile terminal 200 and identification of a preferred terminal based on a security policy and/or other data. In some embodiments, the processor 232 may also be configured to automatically transfer the data (or portions of the data) between the mobile terminal 200, the detected devices, and/or the server 210 over a wireless interface (such as an infrared, Bluetooth, Wi-Fi, and/or cellular connection) responsive to detection of the other devices and identification of the preferred terminal. In other embodiments, the server 210 may be configured to automatically transfer the data. The processor 232 may also include more than one processor, such as, for example, a general purpose processor and/or a digital signal processor, which may be enclosed in a common package or separate and apart from one another.

Although FIG. 2 illustrates an exemplary mobile terminal 200, it will be understood that the present invention is not limited to such a configuration but is intended to encompass any configuration capable of carrying out the operations described herein. For example, although the memory 236 is illustrated as separate from the processor 232, the memory 236 or portions thereof may be included as a part of the processor 232. Also, while the mobile terminal 200 is illustrated as including certain elements, additional and/or fewer elements may actually be provided. For example, a touch sensitive display may be provided in a PDA in place of the display 246 and the keypad 248. More generally, while particular functionalities are shown in particular blocks by way of illustration, functionalities of different blocks and/or portions thereof may be combined, divided, and/or eliminated.

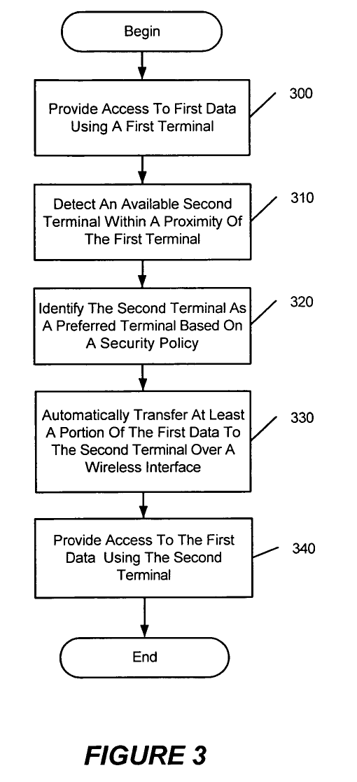

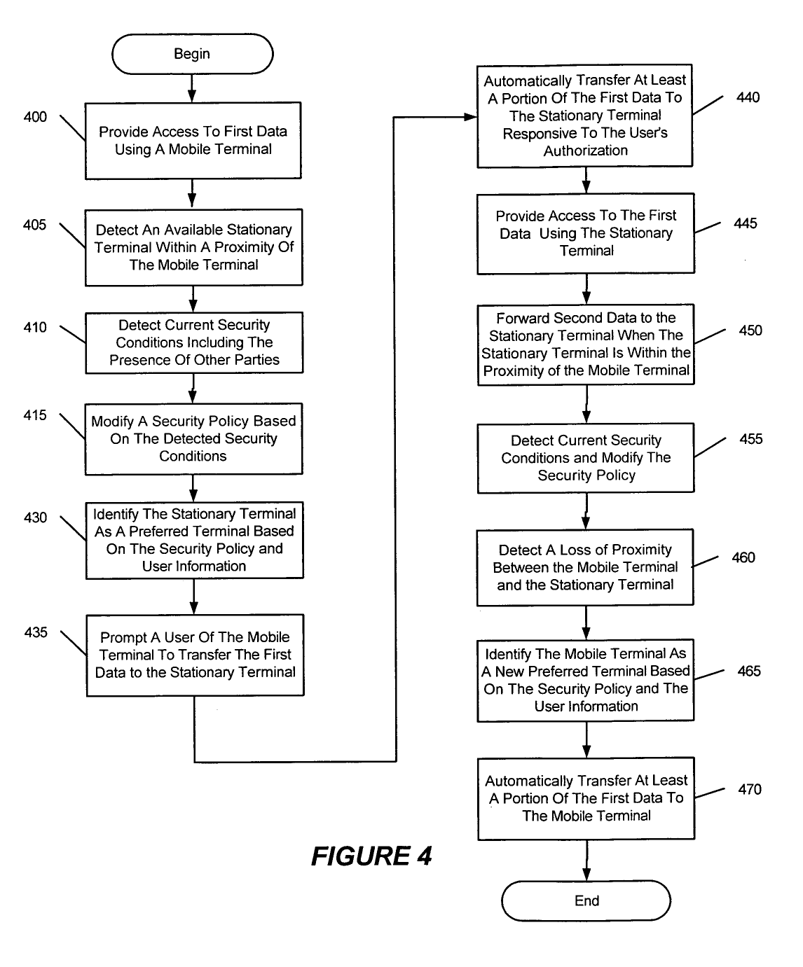

Exemplary operations for accessing data with a plurality of devices in accordance with some embodiments of the present invention will now be described with reference to the flowcharts of FIG. 3 and FIG. 4. These operations may be performed, for example, by one or more of the blocks of FIG. 1.

Referring now to FIG. 3, access to first data is provided using a first terminal at block 300. The data may include text, images, applications, programs, files, and/or any other information that a user may wish to view and/or edit on the first terminal. The first terminal may be configured to detect when access to data is initiated using the device hardware, software API's, and/or the device operating system. In some embodiments, the first terminal may be the mobile terminal 100 of FIG. 1.

An available second terminal is then detected within a proximity of the first terminal at block 310. A terminal may be “available” if a user has authority to use the terminal and/or it is not in use by another party. As used herein, “detecting” a terminal may include detecting the presence of a terminal, as well as detecting the actual identity of a terminal, such as its mobile identification number, Internet Protocol (IP) address and/or other unique identifier. The first and second terminals may detect each other based on identification signals transmitted by each terminal. The identification signals may be wireless signals, such as RF signals, and/or optical signals, such as infrared signals. In some embodiments, the second terminal may be the stationary terminal 105 of FIG. 1.

The second terminal is then identified as a preferred terminal as compared to the first terminal at block 320 based on a security policy. The security policy may include security ratings that are associated with a user of the first terminal, the first data, the first terminal, and/or the second terminal. For example, a security rating for a public PC having a large display with a wide field of view may be lower than a security rating for a PDA with small display because data on the large display may be more easily observed by other nearby parties, which may be undesirable.

More specifically, a device security rating may be initially set by the manufacturer of each terminal, and may contain multiple security sub-ratings. The sub-ratings may include security ratings for the display, access, keyboard input, auditory input, video input, speakers, storage, etc., as different device functions and/or components may provide differing levels of security. The sub-ratings may be set, modified, and/or overridden by user and/or a service provider, to customize as needed. Also, a session security rating may be specified for particular data, such as a particular conversation or usage of an application and/or data file. The session security rating may be set and/or modified by user, via stored preferences and/or at the beginning of a session. The session security ratings may also be inferred from historical data, i.e. based on previous actions by the user and/or similar users. The security ratings may be used as inputs to rules for identifying a preferred terminal.

In some embodiments, the identification of a preferred terminal may also be based on user information, such as the identity of a user, preferences specified by the user (including preferred combinations of devices, applications, and/or display modes), and/or historical determinations of a preferred terminal for the user and/or similar users. For example, user preferences may be used to identify possible options and/or to choose a set of tentative options including a tentative preferred option. Then, security ratings may be used to filter out those options which may be unacceptable from a security/privacy perspective. In some instances, the filtering may alter the tentative preferred option. When two or more options are equally acceptable, one may be randomly chosen. Also, if the current device is one of the tentative options or if none of the tentative options are acceptable, no transfer may take place. In addition, applications and/or data may be blocked and/or hidden based on the security ratings.

Still referring to FIG. 3, at least a portion of the first data is automatically transferred to the second terminal over a wireless interface at block 330 responsive to the detection of the second terminal and the identification of the second terminal as the preferred terminal. As used herein, “automatically” transferring data may refer to a process that involves no user action, or alternatively, limited user action. For example, upon identification of the second terminal as the preferred terminal, the user may be prompted whether to proceed with the transfer. The user prompting may be dependent on the security policy and/or the user preferences. If the user agrees, the transfer may be completed responsive to the user response. Access to first data is then provided using the second terminal at block 340.

The above process may be repeated if additional newly proximal devices are detected and/or if proximity is lost. In some embodiments, the first and second terminal may inform a central server, such as the central server 110 of FIG. 1, of the detection. The central server 110 may then determine that the second terminal is a preferred terminal, so inform the first and second terminals, and automatically transfer at least a portion of the data to the second terminal.

FIG. 4 is a flowchart illustrating detailed operations for accessing data with a plurality of devices in accordance with some embodiments of the present invention. Referring now to FIG. 4, a user is provided access to first data at block 400 using a mobile terminal, such as the mobile terminal 100 of FIG. 1. If the mobile terminal 100 is not shared with other users, the user may be associated with the mobile terminal 100 and may be identified based on a unique owner assignment. Alternatively, a login/password or other means of authentication may be used to associate a user with a commonly-owned mobile terminal, such as a laptop that may be shared with other parties. While accessing the first data with the mobile terminal 100, the user may set preferences and/or provide other information regarding applications, data, input/output (I/O) modes, privacy or security, and/or alerts/notifications, which may be transmitted to the central server 110 and stored in a database. The mobile terminal 100 may also inform the central server 110 that the mobile terminal 100 is the “current” device, and that the first data is being accessed. In some embodiments, the mobile terminal 100 may forward this information to the central server 110 only after proximity to another device is detected.

An available stationary terminal, such as the stationary terminal 105, is then detected within a proximity of the mobile terminal at block 405. For example, the mobile terminal 100 may detect the stationary terminal 105 within 3-5 meters of the mobile terminal 100 using a proximity sensor, and may provide the proximity information to the central server 110. Alternatively or additionally, the central server 110 may monitor the positions of the mobile terminal 100 and the stationary terminal 105 to determine when the terminals 100 and 105 are within a predetermined proximity. For example, the terminals 100 and 105 may determine their relative positions using GPS receivers, and may communicate their positions to the central server 110.

Current security conditions associated with the mobile terminal 100, the stationary terminal 105, the first data, and/or a user of the mobile terminal are then detected at block 410. Detection of current security conditions may include detecting the presence of other parties and/or devices within a proximity of the stationary terminal 105. This presence may be directly sensed and/or inferred from motion using well-known sensor technology, such as microwave, infrared, and/or ultrasonic sensors, which may be included in the proximity sensor 220 of FIG. 2. Also, multiple sensors may be used to provide approximate directional information about the other parties and/or devices present. For example, as described above, four sensors in a tetrahedral arrangement may provide three-dimensional directional information. Alternatively or additionally, an electronic compass and a gravity sensor may be used to provide an approximate coordinate system. The mobile 100 and/or stationary 105 terminals may also network with fixed sensors near the location of the stationary terminal 105 to detect the presence of other parties and/or devices. For example, if motion sensors are utilized, motion detected during a prior interval, such a prior 45-second period, may be used to infer a likely presence of other parties within a proximity of the stationary terminal 105. Also, to avoid self-detection, motion detected during a 15-second period prior to the approach of the user may be ignored. Multiple sensor types, requiring agreement, may also be used to reduce false detections.

A security policy is modified based on the detected security conditions at block 415. The security policy may include security ratings that are associated with a user of the mobile terminal, the first data, the mobile terminal, and/or the stationary terminal, and may be stored in a database in the central server 110. As such, the security ratings for each terminal may be modified based on the type of terminal, the location of the terminal, connections to the terminal, and/or presence of others within a vicinity of the terminal. For example, if the presence of other parties is detected within a proximity of the stationary terminal 105, the device security rating associated with the stationary terminal 105 is modified (i.e. to a lower security rating) to reflect the presence of the other parties. In addition, the user may be warned of the reduced security associated with the stationary terminal 105. The security policy may also specifically include a presence security rating for the proximity sensor 220. The presence security rating may be initially set by manufacturer of the proximity sensor 220, and may contain multiple security sub-ratings. The sub-ratings may include sensor type, far range, near range, on-axis, off-axis, high light, low light, etc., as different aspects of presence sensing may provide differing levels of security and/or accuracy. Some or all of the sub-ratings may be set, modified, and/or overridden by user and/or a service provider.

The stationary terminal is then identified as a preferred terminal based on the security policy and/or user information at block 430. The user information may include the identity of a user, preferences specified by the user, and/or historical determinations of a preferred terminal for the user and/or similar users. For example, user preferences may include preferences regarding devices, applications, data, input/output modes including display modes, sessions, situations, services, locations, and/or time of day. The user may also associate preferences for particular stationary devices with particular locations. The user may set preferences initially, and may later modify the preferences (e.g., via device input, web page, or messaging), such as upon starting a new session/service/communication. Identification of the preferred terminal may also be determined based on the identity of the user, such as by considering similar session preference settings and/or historical data for that user and/or similar users. The historical data may be weighted toward recent data, and older data may be deleted over a predetermined and/or configurable period. Also, data from similar users may be determined and/or identified by users being placed in the same user profile or category, for example, by a service provider, via self-selection, and/or by off-line analysis and/or correlations of historical data.

The identification of the preferred terminal at block 430 may be responsive to the detection of the stationary terminal 105 within the proximity of the mobile terminal 100 and/or the detected security conditions. In some embodiments, the central server 110 may obtain device security ratings, session security ratings, presence security ratings, user and/or similar preferences, and/or user history, and may process these parameters to identifying the preferred terminal. Furthermore, the central server 110 may store such information as historical data for future determinations of a preferred terminal.

Once the stationary terminal 105 is identified as the preferred terminal, the user of the mobile terminal 100 is prompted as to whether the first data should be transferred to the stationary terminal at block 435. If the user decides to continue accessing the first data on the mobile terminal 100, the user may override the transfer by an appropriate response to the prompt. If the user decides that the identified preferred terminal is acceptable, at least a portion of the first data is automatically transferred to the stationary terminal 105 at block 440 responsive to the user's authorization. The central server 110 may implement the transfer, and inform the mobile terminal 100 and the stationary terminal 105 of the results. In addition, the central server 110 may identify the stationary terminal 105 as the “current” device, and may modify network connections accordingly. The transfer of the first data may include transferring the first data to an identical application on the stationary terminal 105, or alternatively, transferring the data to a different application on the stationary terminal 105, depending on the security policy and/or user preferences. The transfer may be saved by the central server 110 as historical data for modifying the security policy and/or the user information. Access to the first data is then provided using the stationary terminal 105 at block 445.

As the stationary terminal 105 is identified as the current device, second data that is addressed to the mobile terminal 100 may be forwarded to the stationary terminal 105 at block 450 while the mobile terminal 100 is within the proximity of the stationary terminal 105. The second data may include e-mail, network communications, and/or other information that would usually be sent to the mobile terminal 100. Additional data may also be forwarded to the stationary terminal 105 as long as it remains the current device.

Current security conditions may be monitored and the security policy may be accordingly modified while the mobile terminal 100 is within the proximity of the stationary terminal 105 at block 455. If a change in security conditions is detected, the security policy may be modified for appropriate action. For example, access to the first data may be blocked and/or hidden due to detection of other parties within a proximity of the stationary terminal 105.

When the user walks away from the stationary terminal 105, a loss of proximity between the mobile terminal 100 and the stationary terminal 105 is detected at block 455. The loss of proximity may be determined based on reduced signal strength, signal timing, and/or location signals transmitted by the terminals 100 and 105, as described above. An audible and/or visible alert may be provided by the mobile terminal 100 and or/the stationary terminal 105 when a loss of proximity between the mobile terminal 100 and the stationary terminal 105 (and/or other detected devices) is detected, as well as when a loss of communication between the mobile 100 and stationary 105 terminals is detected so that data may be transferred manually. An alert may also be provided by the central server 110 to users, operators, and/or administrators when messages or message pattern between the terminals 100 and 105 and the central server 110 appear to be more frequent, invalid, and/or otherwise suspicious. The mobile terminal 100 is then identified as the new preferred terminal based on the security policy and/or the user preferences at block 460. At least a portion of the first data is automatically transferred back to the mobile terminal 100 at block 465. As described previously, the user may be prompted to authorize the transfer back to the mobile terminal, depending on the security policy and/or the user preferences.

The flowcharts of FIG. 3 and FIG. 4 illustrate the architecture, functionality, and operations of some embodiments of methods, systems, and computer program products for accessing data with a plurality of devices. In this regard, each block represents a module, segment, or portion of code, which comprises one or more executable instructions for implementing the specified logical function(s). It should also be noted that in other implementations, the function(s) noted in the blocks may occur out of the order noted in FIG. 3 and FIG. 4. For example, two blocks shown in succession may, in fact, be executed substantially concurrently or the blocks may sometimes be executed in the reverse order, depending on the functionality involved.

Operations of a system for accessing data with a plurality of devices in accordance with some embodiments of the present invention are illustrated by the following example. This example shall be regarded as merely illustrative and shall not be construed as limiting the invention. In this example, Matthew has subscribed to privacy-protected “follow me” service available from a service provider, and has installed the associated software on his PC's and other devices. Matthew is walking through his office building using his wireless PDA 100 to access financial spreadsheets on his company's accounting server, waiting for his wife to arrive for lunch.

As Matthew passes a shared PC 105 in a central area of the office, his PDA 100 and the PC 105 detect that they are close to each other, identify each other, and so inform a central server 110. The central server 110 determines that Matthew is the user of the PDA 100, that the PDA 100 is the “current device,” that the current session is a spreadsheet application/program executing on the PDA 100 and providing access to a remote file on the accounting server. The central server 110 also determines that there has been no motion detected at the shared PC 105 for a considerable time period.

The central server 110 accesses a preference and history database to determines Matthew's preferences. The central server 110 also determines security ratings associated with the terminals 100 and 105, session, and detected presence. It processes these inputs based on a security policy, and determines a set of tentative options, including a tentative preferred terminal. In this case, the central server 110 determines that the preferred option is to transfer the interaction to the shared PC 105. However, this may not have been the case if the presence of other parties was detected at or near the shared PC 105. The central server 110 then informs the PDA 100 and PC 105 of the preferred option, and the data is transferred to the PC 105.

Mathew's PDA 100 beeps, and a pop-up prompt temporarily appears on its screen. The prompt informs Matthew of the transfer, and also allows him to override the transfer if he desires. Matthew chooses not to override the transfer, appropriately responds to the prompt, and turns to the PC 105. The PC 105 informs the central server 100 that it is now the new “current” device, and Mathew sits and edits the spreadsheet on the PC 105 using a suitable same or similar application/program, finding this considerably easier due to the larger keyboard and display screen of the PC 105.

Matthew's wife then arrives in the lobby of his office, and sends Matthew an e-mail from her cell phone. The e-mail service consults the central server 110 to determine the current device, and the e-mail (or other “second data”) is forwarded to the shared PC 105. Matthew continues editing the spreadsheet on the PC 105 until his wife's email arrives at the PC 105. The e-mail does not arrive at the PDA 100, as it is no longer the current device. Matthew reads the e-mail on the PC 105 and learns that his wife waiting for him in the lobby.

Matthew then quickly leaves the PC 105, and the PC 105 and PDA 100 inform the central server 110 that they are no longer within a proximity of one another. The central server 110 repeats the above-described process and determines that the PDA 100 is now the preferred device (since it is Mathew's personal device and was previously the current device), and that the preferred option is to transfer the data back to the PDA 100. The central server 110 so informs the PC 105 and PDA 100, and the spreadsheet data is transferred back to the PDA 100. The PDA 100 beeps, and a pop-up prompt temporarily appears on its screen, informing Matthew of the completed transfer as he catches the elevator down to the lobby.

In the drawings and specification, there have been disclosed embodiments of the invention and, although specific terms are employed, they are used in a generic and descriptive sense only and not for purposes of limitation, the scope of the invention being set forth in the following claims.

That which is claimed is:

1. A method of accessing data with a first terminal and a second terminal, comprising:
providing access to first data using a first terminal;
detecting an available second terminal within a proximity of the first terminal;
identifying the second terminal as a preferred terminal based on a security policy;
automatically transferring at least a portion of the first data to the second terminal over a wireless interface responsive to detection of the second terminal and identification of the second terminal as the preferred terminal; and
providing access to the first data using the second terminal.

2. The method of claim 1, wherein:
the first terminal comprises a mobile terminal; and
the second terminal comprises a stationary terminal.

3. The method of claim 1, wherein identifying the second terminal as a preferred terminal based on a security policy comprises identifying the second terminal as a preferred terminal based on security ratings that are associated with a user of the first terminal, the first data, the first terminal, and/or the second terminal.

4. The method of claim 3, further comprising:
detecting current security conditions associated with a user of the mobile terminal, the first data, the first terminal, and/or the second terminal; and
modifying the security ratings based on the detected security conditions.

5. The method of claim 4, wherein detecting current security conditions comprises detecting a presence of other parties within a proximity of the second terminal and/or other connections to the second terminal.

6. The method of claim 5, wherein detecting the presence of other parties comprises detecting a third terminal within a proximity of the first terminal.

7. The method of claim 1, wherein identifying a preferred terminal further comprises identifying the second terminal as a preferred terminal based on an identity of a user, preferences specified by the user, and/or historical determinations of a preferred terminal for the user and/or similar users.

8. The method of claim 1, wherein:
identifying the second terminal as a preferred terminal comprises accessing a security policy stored on a central server; and
automatically transferring comprises automatically transferring at least a portion of the first data to the second terminal via the central server.

9. The method of claim 1, further comprising:
redirecting second data addressed to the first terminal to the second terminal when the second terminal is within the proximity of the first terminal.

10. The method of claim 1, further comprising:
detecting a loss of proximity between the first terminal and the second terminal;
identifying the first terminal as a preferred terminal based on the security policy; and
automatically transferring at least a portion of the first data to the first terminal responsive to detecting the loss of proximity and identification of the first terminal as the preferred terminal.

11. The method of claim 1, wherein automatically transferring comprises:
prompting a user of the mobile terminal to authorize transferring the first data to the second terminal; and
transferring the first data to the second terminal responsive to a user authorization.

12. A system for accessing data with a plurality of devices, comprising:
a first terminal configured to provide access to first data;
a second terminal configured to provide access to the first data;
wherein the first terminal is further configured to detect the second terminal within a proximity of the first terminal, identify the second terminal as a preferred terminal based on a security policy, and automatically transfer at least a portion of the first data to the second terminal over a wireless interface responsive to detecting the second terminal and determining the preferred terminal.

13. The system of claim 12, wherein the security policy comprises rules for determining the preferred terminal using predetermined and/or user-defined security ratings associated with a user of the mobile terminal, the first data, the first terminal, and/or the second terminal.

14. The system of claim 12, wherein the first terminal comprises a mobile terminal and wherein the second terminal comprises a stationary terminal.

15. The system of claim 14, wherein the first terminal further comprises:
a central server configured to communicate with the mobile terminal and the stationary terminal,
wherein the central server is configured to detect the stationary terminal within a proximity of the mobile terminal, identify the stationary terminal as a preferred terminal based on a security policy, and automatically transfer at least a portion of the first data to the stationary terminal over a wireless interface responsive to detecting the stationary terminal and determining the preferred terminal.

16. The system of claim 15, wherein the central server is further configured to detect current security conditions associated with a user of the mobile terminal, the first data, the mobile terminal, and/or the stationary terminal and modify the security policy based on the detected security conditions.

17. The system of claim 16, wherein the current security conditions comprise other parties within a proximity of the stationary terminal and/or other network connections to the stationary terminal.

18. The system of claim 15, wherein the central server is further configured to identify the stationary terminal as a preferred terminal based on an identity of a user, preferences specified by the user, and/or previous determinations of a preferred terminal for the user and/or similar users.

19. The system of claim 15, wherein the central server is further configured to detect a loss of proximity between the mobile terminal and the stationary terminal, identify the mobile terminal as a preferred terminal based on the security policy, and automatically transfer at least a portion of the first data to the mobile terminal responsive to detecting the loss of proximity and determining the new preferred terminal.

20. A computer program product for accessing data using a first terminal and a second terminal, comprising:
a computer readable storage medium having computer readable program code embodied therein, the computer readable program code comprising:
computer readable program code that is configured to provide access to first data using a first terminal;
computer readable program code that is configured to detect an available second terminal within a proximity of the first terminal;
computer readable program code that is configured to identify the second terminal as a preferred terminal based on a security policy;
computer readable program code that is configured to automatically transfer at least a portion of the first data to the second terminal over a wireless interface responsive to detecting the second terminal and identifying the second terminal as the preferred terminal; and
computer readable program code that is configured to provide access to the first data using the second terminal.
